(19) United States
(12) Patent Application Publication
(10) Pub. No.: US 2021/0286834 A1
(43) Pub. Date: Sep. 16, 2021

(54) SYSTEM AND METHOD FOR DYNAMIC, GRAPH-BASED NOTE-TAKING

(71) Applicant: David Morse, New York, NY (US)

(72) Inventor: David Morse, New York, NY (US)

(21) Appl. No.: 17/183,601

(22) Filed: Feb. 24, 2021

Related U.S. Application Data
(60) Provisional application No. 62/987,804, filed on Mar. 10, 2020.

(51) Int. Cl. G06F 16/34; G06N 5/02; G06F 16/901; G06F 16/906; G06F 16/903; G06F 40/174

(52) U.S. Cl. CPC G06F 16/345; G06N 5/02; G06F 40/174; G06F 16/906; G06F 16/903; G06F 16/9024

(57) ABSTRACT

A system and method for expressing and storing information in a dynamic, graph-based form is disclosed. The method is configured for automatically organizing, summarizing, suggesting connections among, and consolidating that information. The method detects similarity between knowledge graphs and using such similarities to suggest connections, derive prototypic conceptual structures, and merge multiple knowledge graphs. The knowledge is represented as a directed graph comprising a set of labeled nodes and a set of labeled, weighted, directed edges. The conceptual objects correspond to a node or group of nodes, where relations correspond to an edge, a path, or a set of paths between one conceptual object and another. In the knowledge graph, any statement could be represented as a relation between conceptual objects.

### BACKGROUND OF THE INVENTION

Note-taking is the practice of recording and organizing information. Note-taking often takes the form of bullet points or writing. Yet, while lines of words, for example, sentences or bullets, stacked on top of each other, fit well onto a rectangular sheet of paper, they fail to fully reflect how people think. While it is often most effective to communicate or ingest information in a linear sequence of words, information itself is rarely linear.

It is an established view in the fields of cognitive science, psychology, and natural language processing that people think and store thoughts in terms of connections. Any statement, for example, “Harry loves Sally,” with a subject, predicate, and object may be interpreted through this lens as a bilateral connection between two conceptual objects: the predicate connects the subject to the object.

In addition, proponents of distributional semantics contend that concepts get their meaning in people's minds from their causal connections to other concepts. Causal connection, as used herein, denotes a tendency on behalf of the knowledge-holder to proceed from paying attention to one concept to paying attention to another. The strength of a causal connection denotes the extent to which, when the source concept is present in one's mind, the latter then becomes present. A definition of a concept, in this view, is not separate from that concept's associations, as logical purists may suppose, but rather a concept's definition consists in that concepts often many connections to other concepts. Connotations of a concept, as opposed to a definition of a concept, in this view, are just weaker connections. For example, the concept of the “US” is strongly connected to the concept of “America,” and less strongly connected to the concept of “New York”.

Insofar as people think in terms of connections between concepts and insofar as concepts obtain meaning primarily from their causal connections to other concepts, linear methods of recording information are lacking. It is the responsibility solely of the reader to find and interpret semantic connections in an essay, i.e., to understand the interconnected concepts it includes and the nature of those connections. When two similar academic essays are published, only a reader can come to understand how they interact with each other. Linear mediums do not do any of the connecting work.

Due to the dominance of linear media for recording and sharing information, people often do not expect that the medium they use to record information can or should possess an understanding of the information it holds or organize the information meaningfully. As a result, literate people, in dealing with writing and bullet-points, have become accustomed to certain effort- and time-consuming processes that, upon scrutiny, do not seem necessary. They have become used to transforming linear sequences of words into a more digestible non-linear form, used to converting thoughts (mentally stored and understood in terms of connections between concepts) into linear sequences of thoughts, and used to taking the near-full responsibility for interpreting and finding connections in the contents of external media. All these translational processes can be seen as the product of a constraint, the rectangular sheet of paper, which is no longer necessary for our recording information.

There is a format for recording information based around connections called a concept map. Concept maps are spatial representations of knowledge, in which a concept is represented as a circle (node) and a connection/statement is represented as a line connecting two circles (edge). But concept mapping is limited in its current forms. Making a concept map is messy and often when handwritten. It is very difficult to have enough foresight in making a concept map as to prevent lines (representing edges) from crossing each other all over the page. Moreover, though concept maps have advantages over bullet points and other linear note-taking techniques in their ability to store and model nonlinear knowledge, existing software that is meant for creating concept maps is meant more for presentational purposes, e.g., creating a diagram that might be included in a report, than for recording notes in real time and understanding, organizing, or manipulating notes.

Henceforth, there is a need for a system and method for expressing and storing information in a dynamic, graph-based form and enabling people to record, organize, understand, and manipulate knowledge more effectively. Also, there is a need for a method for automatically organizing, summarizing, suggesting connections among, and consolidating that information.

### SUMMARY OF THE INVENTION

The present invention discloses information technology. The present invention further discloses a system and method for expressing and storing information in a dynamic, graph-based form, and methods for automatically organizing, summarizing, suggesting connections among, and consolidating that information.

In one embodiment, the present invention provides a digital interface that can store, present, manipulate a knowledge graph in the described manner. In one embodiment, the present invention provides a method of detecting similarity between knowledge graphs and using such similarity to suggest connections, derive prototypic conceptual structures, and merge multiple knowledge graphs.

In one embodiment, a computer-implemented method for rendering a dynamic, graph representing a set of notes is disclosed. The method comprises the following steps. At one step, the knowledge graph is rendered in bullet-point form. In one embodiment, the rendering of knowledge graph as bullet-points, comprising the steps of : accessing a particular node in a knowledge graph, wherein each node has associated identifying information; ranking the most relevant relations in the graph in an order based on their relevance, wherein, to reiterate, the relation is implemented in the knowledge graph either as an edge between two nodes or as a path or set of paths between two given nodes, and outputting a list of entries corresponding to each ranked relation, where each entry is a statement represented by information corresponding to the source conceptual object of the relation, the relation itself, and the target conceptual object of the relation. In one embodiment, the rendering of knowledge graph as bullet-points further comprises: accessing a log, in chronological order, of the edges most recently added to the knowledge graph, and ranking the most relevant relations, wherein the relevance of a given relation corresponds to the recency of its addition to the knowledge graph. Optionally, in one embodiment, as a first step in the instantly taught method, an edge of a knowledge graph is converted, where a relation is represented into an edge-node-edge structure, a relation and a conceptual object. In a related embodiment, the relation is implemented as an edge from a source node to a target node into a conceptual object.

At another step, a user's process of inputting and submitting a query is streamlined. In one embodiment, the streamlining of note-adding comprises: accessing a set of items and a certainty threshold; inputting the query as a string; monitoring a user's input as the user is in the process of inputting a query; determining at various instances of inputting a query whether the likelihood that the part of the query that the user has input singles out a particular item in the given set exceeds the given certainty threshold, and submitting the query for the user upon determining that the threshold has been exceeded (that is, without requiring the user to indicate that they are finished with the query). In one embodiment, the information about the likelihood of any item's being sought out in a query is given by an element-ranking algorithm like PageRank. One unique part of this method is that the query is submitted without the user's explicit indication/effort to indicate that they would like to submit the query.

In one embodiment, the determination of whether the likelihood (that the part of the query that the user has input singles out a particular item) exceeds the threshold comprises: comparing the likelihood-information associated with the first most likely item with the likelihood-information associated with other highly likely items, and finding that the threshold has been exceeded if the discrepancy between the items' likelihoods are sufficient for the first item to be output as the result of the query.

At another step, note-adding is streamlined by enabling a user to quickly add an edge to a knowledge graph. In one embodiment, the streamlining of note-adding comprises a repository of notes that are stored as the knowledge graph; ranking the conceptual objects and relations in the knowledge graph; taking user inputs for a source node identifier, a target node identifier, and an edge name; outputting and filtering the query for a conceptual object or relation, a menu containing the highest ranked conceptual objects or relations, respectively, and auto-filling the selected item from the menu in the input field. In one embodiment, the streamlining of note-adding further comprises: auto-filling the input field, for each change made to a source or target node input field, with suggested information associated with the highest ranked node that matches the part of the query that has been input, and auto-filling the input field, for each change made to the edge name input field, with suggested information associated with the highest ranked edge that matches the query that part of the query that has been input.

At another step, the notes are summarized via clustering by taking the knowledge graph as input and a desired range for the number of clusters. In one embodiment, the process of summarizing the notes includes: taking input a knowledge graph (which may itself be a sub-graph of a larger knowledge graph), a desired range for the number of clusters to be found, applying some clustering algorithm to the knowledge graph to find k clusters of nodes, where k is in the desired range, rendering to a viewer of an associated note-interaction system informational highlights concerning individual clusters of the clusters of concepts that are found wherein such representative information may include information that relates in particular to a medoid in each given cluster.

At another step, similar sub-graphs are determined by finding a measure of semantic similarity between parts of the knowledge graph. In one embodiment, the determination of similar sub-graphs further comprising: computing the similarity between various pairs of sub-graphs of the knowledge graph; finding sets of sub-graphs whose members' similarity with each other exceeds a certain threshold, and outputting the sets to a user or to further processing steps. In one embodiment, the determination of similar sub-graphs further comprises: accessing information about the importance of each node in a subset of the nodes of the knowledge graph, and prioritizing, in the similarity computations, sub-graphs that are those more closely related to nodes with higher levels of importance, wherein the prioritization of the given sub-graph corresponds to considering its comparisons with other sub-graphs earlier than other comparisons.

In one embodiment, the prioritization of a given sub-graph corresponds to considering its comparisons with other sub-graphs earlier than other comparisons. In one embodiment, the determination of similar sub-graphs further provides suggestions for possible modifications of the graph based on the sets of sub-graphs whose members have been determined to be sufficiently similar to each other. In one embodiment, each suggested modification constitutes the proposal of a connection between two conceptual objects, which are not already directly connected and which are contained within sub-structures that have been determined as similar to each other.

In one embodiment, the method further includes abstracting prototype from similar substructures, which includes constructing, for each set of similar sub-graphs, a prototypical knowledge-graph structure (composed of nodes and edges) that is derived from the sub-graphs in the set, either by abstraction to capture their similarities or by combining them so as to keep all of their features; adding some of the constructed prototype knowledge graph structures to the larger knowledge graph that contains the original sub-graphs that were identified as similar, and adding edges to connect the prototypical structure to some of the sub-graphs that belong to the category that the prototype represents.

In one embodiment, computing similarities and constructing prototypes further comprises: ranking the prototypes according to the efficiency that would be achieved in the given knowledge graph by replacing all instances of each prototypical structure with a short identifying key for that structure, wherein such efficiency may be calculated from: the complexity of the prototypic structure and the number of sub-graphs in the set from which the prototype was derived. In one embodiment, computing similarities and constructing prototypes further comprises outputting a recommendation that a given verbal language includes a word or phrase that denotes the highest ranking prototypical knowledge graph structures. In one embodiment, the verbal language is that primarily used in the construction or viewing of the knowledge graph.

At another step, the knowledge graphs are merged by determining the sets of similar nodes. In one embodiment, the sets of similar nodes are determined, wherein each set consists of one or no sub-graph from each of the N knowledge graphs. The similarity measures between any two members of a such a set exceeds a threshold number. For members of each such set of similar nodes, either: connecting all nodes in the set to each other node in the set, by constructing edges connecting the nodes to each other so as to connect previously disparate knowledge graphs, and replacing each of these nodes with one super node that has the connections possessed by the corresponding original nodes in this set. In one embodiment, the nodes in any such set of similar nodes to be connected or superimposed, a user must first provide consent that this connection/superimposition should occur.

At another step, a shared knowledge graph is rendered that has been created, modified, and traversed by a set of users. In one embodiment, the rendering of shared knowledge graph comprises: taking as input all of the contributions made by each individual user to the contemporaneous state of the knowledge graph which includes but not limited to: (a) data concerning interactions with any node or edge, including by creating, selecting, focusing on, or editing the node or edge, (b) data indicating which interactions have involved a particular set of users U that are of interest, and rendering each element of the knowledge graph such that the element's prominence depends, not necessarily equally, on: the extent to which users in U have interacted with that element, the extent to which the rest of the users interacting with the knowledge graph have been interacting with the knowledge graph.

At another step, a human preference is satisfied using the knowledge graph. In one embodiment, satisfying the preference is not wholly implemented in a physiological (carbon-based) medium. The knowledge graph includes conceptual objects that, when activated, trigger actions. A set of preferences is given, wherein a “preference” comprises the aim of either increasing or decreasing the strength of the relation among a given group of conceptual objects. The strength of a preference may depend on the current extent to which it is satisfied.

In one embodiment, a note-interaction system is disclosed that stores notes and connections between them as a knowledge graph and implements any of the above-described methods. In one embodiment, the output device is a digital viewport. In one embodiment, the system comprises an input device through which a user can enter information that affects the presentation or the content of the stored notes.

In one embodiment, the clustering method applies to the part of the knowledge graph being outputted. The clustering method is executed, either automatically or on the user's indication, if there the part of the knowledge graph being outputted (and clustered) changes. The desired range for the number of clusters is meant to present the user with an ingestible amount of information.

In one embodiment, the output device is a digital viewport in and out of which a user can zoom. The knowledge graph is rendered via the output device as a concept map, wherein conceptual objects are rendered distinctly from relations. Each cluster being represented is itself interpreted and rendered as a conceptual object, wherein: the conceptual object corresponds to a node in the knowledge graph that has all of the connections of the underlying nodes it represents, editing data that represents the cluster is stored as edits to the data associated with either a medoid of the cluster or a newly constructed node that is just as central if not more central to the cluster than any originally designated medoid.

In one embodiment, the system further comprises comprising a binary mode, which, when on, instructs the system to recompute k clusters of conceptual objects (within the desired range) when the set of conceptual objects included in the viewport changes. The system comprises a method that on receiving a certain kind of user input concerning a given connection, the system will convert the given connection into a conceptual object using the method of the instantly taught disclosure. In one embodiment, on receiving a certain kind of user input concerning a given conceptual object, the system will classify the given conceptual object as a relationship for the purpose of rendering it as such.

In one embodiment, the user can change the part of the knowledge graph that is being outputted or clustered by: zooming out, which, as used herein, means viewing both the notes that the user was originally viewing as well as some additional notes that are related to the notes she was previously viewing (all in possibly less detail than she was originally viewing them), zooming in, which, as used herein, means viewing a proper subset of the notes that the user was originally viewing, and also maybe additional information pertaining to the notes in the targeted proper subset., and traversing relations, i.e., navigating away from certain notes in the viewport and bringing other notes into the viewport.

In one embodiment, a plurality of users have inputted information that has affected the presentation or content of the notes. In one embodiment, there is a community of users associated with a shared knowledge graph, wherein: such users have the power to view or edit parts of said knowledge graph. In order for a user to contribute to a community's associated knowledge graph, the community is open to said user and the user opts into joining the community.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIGS. 1A-1B exemplarily illustrate two ways in which a relationship between two conceptual objects stored in a knowledge graph may be represented, according to an embodiment of the present invention;

FIGS. 2A-2B exemplarily illustrate the makeup of a certain complex conceptual object and a certain complex relation between conceptual objects, according to an embodiment of the present invention;

FIG. 3 exemplarily illustrates a concept map representing a portion of a knowledge graph, according to an embodiment of the present invention;

FIG. 4 exemplarily illustrates a page with a title and bullet points, representing a portion of a knowledge graph, according to an embodiment of the present invention;

FIG. 5 exemplarily illustrates a series of snapshots for treating a relationship as a conceptual object that represents a knowledge graph as bullet points, according to an embodiment of the present invention;

FIGS. 6A-6B exemplarily illustrate a table representing a set of items and their relevance scores along with a series of snapshots illustrating one embodiment of a method for fast querying, according to an embodiment of the present invention;

FIGS. 7A-7C exemplarily illustrate a series of snapshots illustrating a method for enabling a user to quickly add connections to a knowledge graph, according to an embodiment of the present invention;

FIG. 8 exemplarily illustrates a concept map representing a knowledge graph, overlaid with circles representing a set of three clusters that may be detected for the knowledge graph, according to an embodiment of the present invention;

FIGS. 9A-9B exemplarily illustrate a series of snapshots of a system that represents clusters as conceptual objects, according to one embodiment of the present invention;

FIGS. 10A-10B exemplarily illustrates a pair of snapshots illustrating how a system that renders parts a knowledge graph as bullet points could enable a user to summarize notes by employing a method involving clustering, according to one embodiment of the present invention;

FIG. 11 exemplarily illustrate a diagram representing the addition of a connection incident to cluster that is being treated as a conceptual object, according to one embodiment of the present invention;

FIGS. 12A-12B exemplarily illustrates a diagram illustrating methods involving similarity calculations, including a table demonstrating similarity calculations, where similarity is based on closeness, as well as a concept map demonstrating structural similarity between two knowledge graphs, according to one embodiment of the present invention;

FIG. 13 exemplarily illustrates a concept map representing a knowledge graph in which a prototype has been constructed to represent the similarity of a pair of similar knowledge graphs, according to one embodiment of the present invention;

FIGS. 14A-14C exemplarily illustrates a set of concept maps representing a method of merging the two knowledge graphs into a third knowledge graph, according to one embodiment of the present invention;

FIG. 15 exemplarily illustrates a concept map illustrating a process of preference satisfaction in a system that has a concept map and a preference, according to one embodiment of the present invention; and

FIG. 16 exemplarily illustrates a concept map illustrating a pair of preferences that is paradigmatic for many people, according to one embodiment of the present invention.

### DETAILED DESCRIPTION

The present invention generally relates to information technology and more particularly relates to a system and method for expressing and storing information in a dynamic, graph-based form and enabling people to record, organize, and manipulate knowledge more effectively.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Before any embodiments of the invention are explained in detail, it is to be understood that the invention is not limited in its application to the details of construction nor to the arrangement of components set forth in the following description or illustrated in the drawings. The invention is capable of other embodiments and of being practiced or of being carried out in various ways.

The term “user” discloses a particular but arbitrarily chosen subset of the following set: intelligent subjects, potentially including non-humans or parts of a human, who have particular intentions, desires, or needs that they attempt to fulfill via taking notes.

The term “note” discloses (a) either an idea or a group of notes. The idea is a thought, or statement that a user stores in a memory device includes, but not limited to, external to the user's mind. The idea, thought, relationship, or statement typically, but does not necessarily, consist of a human-language component, i.e. a part that is written or spoken text. So, while a photograph still qualifies as a note, a photograph with a caption is a more typical manifestation of a note. Conceptual objects and connections are both examples of notes. The group of notes and, optionally, connections between and among the notes, that the user may be storing or has stored in a memory device external to her mind. The component of the note (a) is hereafter referred to as the content of the note. (b) The form in which the content of the note is stored in a memory device. For example, the form in which a handwritten form is stored might be referred to as “handwritten.” The form of the note refers to whatever external memory source stores the note. (The fact that notes necessarily have a form distinguishes notes from ideas, more generally. Ideas need not be tethered to physical reality. Because notes necessarily have a form, they are not just ideas.).

The term “note-taking” discloses a process by which a user creates notes. For a user to create a note, as used herein, is for her to record or commit the content of an idea, thought, or statement to a memory source. The user typically, but not necessarily, undertakes note-taking with the intention of (i) Making the note's content useful in the future. This usefulness often includes, but is not limited to, enabling herself or others to refer to the content of the note in the future, as it might be stored differently (and maybe, in some ways, more losslessly) in the external medium. (ii) Engaging with a note's content during the creation of a note, often in order to better understand and retain it in her mental memory.

The term “note-interaction” discloses the process by which a user interacts with notes during and after she records them (a process which therefore includes note-taking). To interact, as used herein in the context of note-interaction, may include the act of recording notes, as is included in the definition of note-taking, but also may include all others ways of shaping or influencing notes' presentation or contents. Example referents of the word interact are filtering, reading or referencing, and reorganizing.

The term “note-interaction system” discloses a hardware component and a software component. The hardware component comprises a memory source that stores notes and an interface. The interface comprises an output device, through which the user can perceive stored notes, and an input device, through which the user can enter information that can affect the presentation or content of the stored notes. The software component comprises a computer- or agent-readable set of instructions executable by one or more processors or brain-parts for performing functions, wherein the inputs to-be-used can include any information stored in the memory source of the hardware component, any information received through the input device, or any other relevant information. The methods employ algorithms to determine and render information to output through the output device, wherein such information can be representative of parts of the stored knowledge graph.

The term “conceptual object” discloses any coherent unit of information that can be connected to other coherent units of information. A conceptual object may be recorded, making it a note.

The term “connection or relation” discloses any semantic link between two conceptual objects. A directed relation may be said to be associated with one source conceptual object and one target conceptual object. The term “element” discloses a particular conceptual object or relation.

The term “knowledge graph” discloses (a) a directed graph (i.e., network) comprising a set of labeled nodes and a set of labeled, weighted, directed edges that meaningfully represents some knowledge. For a directed graph to be considered a knowledge graph: (i) Each node corresponds to a conceptual object. A node that connects a set of other nodes S may also be interpreted as a relation or connection among the conceptual objects represented by the nodes in S. Finally, a path (a sequence of adjacent edges and nodes, wherein adjacent edges leading into and away from successive nodes) or set of paths between two nodes may also be interpreted as a relation or connection. (ii) Each edge represents a relation or connection from one concept to another. Only nodes can be connected to other nodes. An edge always has a corresponding source node and a corresponding target node. (b) All edges or nodes may be associated with further data, including, but not limited to, (i) a text label and (ii) a weight. For the sake of clarity, “weights” are associated with edges, whereas “emphasis values” are associated with nodes. It should be noted that any sub-graph of a directed graph of a knowledge graph also represents a knowledge graph. Also, any element represented by a node or edge with label x may be abbreviated as [x].

The term “direct connection” discloses any semantic link between two conceptual objects in a knowledge graph that is represented by a single edge. The term “preference in a knowledge graph” discloses the aim of either increasing or decreasing the strength of the relation among a given group of conceptual objects.

The term “set of preferences in a knowledge graph” discloses (a) a set of preferences, (b) a value denoting the extent to which the set of preferences are currently satisfied, hereafter referred to as the satisfaction value of the given preference, and (c) a weight function for assigning weights to each preference, wherein such weights will be taken into account in the calculation of the satisfaction value.

The term “concept map” discloses a visual representation of a knowledge graph or sub-graph thereof, wherein (i) the closed geometric forms, like circles represent conceptual objects, (ii) lines from one closed geometric form to another represent relations between the corresponding conceptual object, and (iii) strings or other additional data that is placed in or near the closed geometric forms or lines represent data associated with the corresponding conceptual objects and relations.

The term “nodify” discloses the process of converting an edge of a knowledge graph, representing a relation, into an edge-node-edge structure, representing a relation and representing a conceptual object, wherein whether it is representing a relation or a conceptual object depends on the context of the other conceptual objects of focus.

Hereinafter, one or more embodiments of the present invention are described in detail with a discussion of representing knowledge and statements in a graph-based format.

According to the present invention, a knowledge can be represented as a directed graph, for example, a network. In one embodiment, the directed graph comprises a set of labeled nodes and a set of labeled, weighted, directed edges, where conceptual objects correspond to a node or group of nodes and their sub-graph. The relations between the nodes correspond to an edge, a path, or a set of paths between one conceptual object and another.

While the mathematical field of graph theory and associated graph algorithms has provided the foundation for the analysis of social networks and biological systems, to give two examples, graph theory and associated graph algorithms have not been applied extensively to people's notes. The form of modern-day notes is often hierarchical, whereas graph algorithms can be most useful in their application to non-hierarchical graphs, and the subjects of graph theoretical analysis are often domains with clean and organized data, whereas notes are often messy and less structured. But if feats of thinking can be accomplished by a computer's application of graph algorithms to notes, the research task of tailoring graph algorithms and designing systems and methods by which they may be applied to our note becomes significant for people everywhere.

In one embodiment, the present invention provides a digital interface that can store, present, manipulate a knowledge graph in the described manner. In one embodiment, the present invention provides a method of detecting similarity between knowledge graphs and using such similarities to suggest connections, derive prototypic conceptual structures, and merge multiple knowledge graphs.

In one embodiment, a computer-implemented method for implementing dynamic, graph-based note-taking is disclosed. In one embodiment, an edge of a knowledge graph is converted, where a relation is represented into an edge-node-edge structure, a relation and a conceptual object. In a related embodiment, the relation is implemented as an edge from a source node to a target node into a conceptual object.

In one embodiment, the method of converting a relation that is in a knowledge graph and is implemented as an edge r from a source node S to a target node T into a conceptual object, comprises: deleting r, constructing a new node R, constructing an edge from S to R, and constructing an edge from R to T. In a related embodiment, the data corresponding to R may include information that corresponded to r, such as: the label of r, the source node of r is S, and the target node of r is T.

At another step, the knowledge graph is rendered in bullet-point form. In one embodiment, the rendering of knowledge graph as bullet-points, comprising the steps of: accessing a particular node in a knowledge graph, wherein each node has associated identifying information; ranking the most relevant relations in the graph in an order based on their relevance, wherein, to reiterate, the relation is implemented in the knowledge graph either as an edge between two nodes or as a path or set of paths between two given nodes, and outputting a list of entries corresponding to each ranked relation, where each entry is a statement represented by information corresponding to the source conceptual object of the relation, the relation itself, and the target conceptual object of the relation.

In one embodiment, the rendering of knowledge graph as bullet-points further comprises: accessing a particular node S that is considered most important; ranking the most relevant relationships wherein S is the source or the target conceptual object; considering the other node O to which a given ranked relation connects S, ranking O's most relevant relationships with other nodes; outputting the list of relationships associated with O in close proximity to the outputted information that corresponds to the relation from S to O (however “proximity” may be defined for the output device), and recursively repeating this ranking process for each ranked relation until a certain threshold for generating relationships (e.g., a recursive depth limit) is met.

In one embodiment, the rendering of knowledge graph as bullet-points further comprises: accessing a log, in chronological order, of the edges most recently added to the knowledge graph, and ranking the most relevant relations, wherein the relevance of a given relation corresponds to the recency of its addition to the knowledge graph.

At another step, a user's process of inputting and submitting a query is streamlined. In one embodiment, the streamlining of note-adding comprising: accessing a set of items and a certainty threshold; taking as input the user's query as a string; monitoring a user's input as the user is in the process of inputting a query; determining at various instances of inputting a query whether the likelihood that the part of the query that the user has input singles out a particular item in the given set exceeds the given certainty threshold, and submitting the query for the user upon determining that the threshold has been exceeded.

In one embodiment, the user is inputting the query as a string through a keyboard. In one embodiment, the streamlining of note-lining includes each of the items of the accessed set is associated with information about its likelihood of being sought out in a query, and the determination of whether the likelihood (that the part of the query that the user has input singles out a particular item) exceeds the given threshold uses the information associated with each item about its likelihood of being sought out in a query. In one embodiment, the set of items of the accessed set represent conceptual objects or relations in a knowledge graph. In one embodiment, the information about the likelihood of any item's being sought out in a query is given by an element-ranking algorithm like PageRank.

In one embodiment, the determination of whether the likelihood (that the part of the query that the user has input singles out a particular item) exceeds the threshold comprises: comparing the likelihood-information associated with the first most likely item with the likelihood-information associated with other highly likely items, and finding that the threshold has been exceeded if the discrepancy between the items' likelihoods are sufficient for the first item to be output as the result of the query.

At another step, note-adding is streamlined by enabling a user to quickly add an edge to a knowledge graph. In one embodiment, the streamlining of note-adding includes a repository of notes that are stored as the knowledge graph comprising: ranking the conceptual objects and relations in the knowledge graph; taking user inputs for a source node identifier, a target node identifier, and an edge name; outputting and filtering the query for a conceptual object or relation, a menu containing the highest ranked conceptual objects or relations, respectively, and auto-filling the selected item from the menu in the input field. In one embodiment, the streamlining of note-adding further comprises: auto-filling the input field, for each change made to a source or target node input field, with suggested information associated with the highest ranked node that matches the part of the query that has been input, and auto-filling the input field, for each change made to the edge name input field, with suggested information associated with the highest ranked edge that matches the query that part of the query that has been input.

At another step, the notes are summarized via clustering by taking the knowledge graph as input and a desired range for the number of clusters. In one embodiment, the process of summarizing the notes includes: taking input a knowledge graph (which may itself be a sub-graph of a larger knowledge graph), a desired range for the number of clusters to be found, applying some clustering algorithm to the knowledge graph to find k clusters of nodes, where k is in the desired range, rendering to a viewer of an associated note-interaction system informational highlights concerning individual clusters of the clusters of concepts that are found wherein such representative information may include information that relates in particular to a medoid in each given cluster.

At another step, similar sub-graphs are determined by finding a measure of semantic similarity between parts of the knowledge graph. In one embodiment, the determination of similar sub-graphs further comprising: computing the similarity between various pairs of sub-graphs of the knowledge graph; finding sets of sub-graphs whose members' similarity with each other exceeds a certain threshold, and outputting the sets to a user or to further processing steps. In one embodiment, the determination of similar sub-graphs further comprises: accessing information about the importance of each node in a subset of the nodes of the knowledge graph, and prioritizing, in the similarity computations, sub-graphs that are those more closely related to nodes with higher levels of importance, wherein the prioritization of the given sub-graph corresponds to considering its comparisons with other sub-graphs earlier than other comparisons.

In one embodiment, the prioritization of a given sub-graph corresponds to considering its comparisons with other sub-graphs earlier than other comparisons. In one embodiment, the determination of similar sub-graphs further provides suggestions for possible modifications of the graph based on the sets of sub-graphs whose members have been determined to be sufficiently similar to each other. In one embodiment, each suggested modification constitutes the proposal of a connection between two conceptual objects, which are not already directly connected and which are contained within sub-structures that have been determined as similar to each other.

In one embodiment, the sub-graphs being examined are each a conceptual object (represented by a node or cluster), and the similarity measure is determined by a distance measure between the two nodes being considered. In one embodiment, the similarity computation takes into account structural resemblance or the similarity of data that is associated with the nodes or edges being compared, for example, their labels, and outputting to a viewer of the knowledge graph information about some sub-graphs groups that have been determined to be most similar to each other, wherein such a grouping is presented as a semantic analog.

In one embodiment, the method further includes abstracting prototype from similar substructures, which includes constructing, for each set of similar sub-graphs, a prototypical knowledge-graph structure (composed of nodes and edges) that is derived the sub-graphs in the set, either by abstraction to capture their similarities or by combining them so as to keep all of their features; adding some of the constructed prototype knowledge graph structures to the larger knowledge graph that contains the original sub-graphs that were identified as similar, and adding edges to connect the prototypical structure to some of the sub-graphs that belong to the category that the prototype represents.

In one embodiment, adding some of the constructed prototype further comprises: deleting the sub-structures of the sub-graphs that are completely isomorphic with their prototype, and constructing edges between the neighboring nodes of the now-deleted substructures and the corresponding parts of the prototypical structure, such that the contents of the sub-graph in the set of sub-graphs that is represented by the given prototype is represented in the modified knowledge graph. In one embodiment, the similarities are computed between sub-graphs that are within a given plurality of knowledge graphs. The prototypes are constructed as abstractions for the corresponding similarity sets. In one embodiment, each prototype constructed is given an identifying key, for example, an associated word, such that it can be easily referenced in the future.

In one embodiment, computing similarities and constructing prototypes further comprises: ranking the prototypes according to the efficiency that would be achieved in the given knowledge graph by replacing all instance of each prototypical structure with a short identifying key for that structure, wherein such efficiency may be calculated from: the complexity of the prototypic structure and the number of sub-graphs in the set from which the prototype was derived. In one embodiment, computing similarities and constructing prototypes further comprises outputting a recommendation that a given verbal language includes a word or phrase that denotes the highest ranking prototypical knowledge graph structures. In one embodiment, the verbal language is that primarily used in the construction or viewing of the knowledge graph.

At another step, the knowledge graphs are merged by determining the sets of similar nodes. In one embodiment, the sets of similar nodes are determined, wherein each set consists of one or no sub-graph from each of the N knowledge graphs. The similarity measures between any two members of a such a set exceeds a threshold number. For members of each such set of similar nodes, either: connecting all nodes in the set to each other node in the set, by constructing edges connecting the nodes to each other so as to connect previously disparate knowledge graphs, and replacing each of these nodes with one super node that has the connections possessed by each of the original nodes in this set. In one embodiment, the nodes in any such set of similar nodes to be connected or superimposed, a user must first provide consent that this connection/superimposition should occur.

At another step, a shared knowledge graph is rendered that has been created, modified, and traversed by a set of users. In one embodiment, the rendering of shared knowledge graph comprising: taking as input all of the contributions made by user to the contemporaneous state of the knowledge graph which includes but not limited to: (a) data concerning interactions with any node or edge, including by creating, selecting, focusing on, or editing the node or edge, (b) data indicating which interactions have involved a particular set of users U that are of interest, and rendering each element of the knowledge graph such that the element's prominence depends, not necessarily equally, on: the extent to which users in U have interacted with that element, the extent to which the rest of the users interacting with the knowledge graph have been interacting with the knowledge graph.

At another step, the preferences are satisfied with the knowledge graph to an extent. In one embodiment, satisfying the preference is not wholly implemented in a physiological (carbon-based) medium. The knowledge graph includes conceptual objects that, when activated, trigger actions. A set of preferences is given, wherein a “preference” comprises the aim of either increasing or decreasing the strength of the relation among a given group of conceptual objects. The strength of a preference takes into account the current extent to which it is satisfied.

In one embodiment, the method includes modifying the knowledge graph so as to increase the extent to which the set of preferences are satisfied (a) by means such as: adding or removing edges, altering the strengths of edges, adding or removing nodes, (b) optionally subject to a set of constraints or cost function, and outputting paths between the given set of conceptual objects for all or some of the given preferences. In one embodiment, the potential modifications of the graph are evaluated based on a cost function that associates costs with adding nodes or edges to the knowledge graph. In one embodiment, the set of preferences includes either or both of the following: (a) a preference that includes the aim of increasing the strength of the relation between a first conceptual I and a second conceptual object and a preference that includes the aim of decreasing the strength of the relation between I and (b) a second conceptual object.

In one embodiment, a fixed quantity denoting the amount of attention any node is receiving or should receive at a given moment, hereafter referred to as emphasis, is distributed among the nodes in the knowledge graph. Emphasis is transferred from one node to another through edges, optionally wherein the amount of emphasis that transfers through an edge corresponds to the edge's weight. Emphasis originates from nodes that correspond to the conceptual object I (The aim of increasing the strength of the relation between a first conceptual object I and a second is, therefore, the aim of increasing the emphasis of the second conceptual object.).

In one embodiment, a note-interaction system that stores notes and connections between them as a knowledge graph and implements any of the above-described methods. In one embodiment, the output device is a digital viewport. In one embodiment, the system comprises a input device through which a user can enter information that affects the presentation or the content of the stored notes.

In one embodiment, the clustering method applies to the part of the knowledge graph being outputted. The clustering method is executed, either automatically or on the user's indication, if there the part of the knowledge graph being outputted (and clustered) changes. The desired range for the number of clusters is meant to present the user with an ingestible amount of information.

In one embodiment, the output device is a digital viewport in and out of which a user can zoom. The knowledge graph is rendered via the output device as a concept map, wherein conceptual objects are rendered distinctly from relations. Each cluster being represented is itself interpreted and rendered as a conceptual object, wherein: the conceptual object corresponds to a node in the knowledge graph that has all of the connections of the underlying nodes it represents, editing data that represents the cluster is stored as edits to the data associated with either a medoid of the cluster or a newly constructed node that is just as central if not more central to the cluster than any originally designated medoid.

In one embodiment, the system further comprises comprising a binary mode, which, when on, instructs the system to recompute k clusters of conceptual objects (within the desired range) when the set of conceptual objects included in the viewport changes. The system comprises a method that on receiving a certain kind of user input concerning a given connection, the system will convert the given connection it into a conceptual object using the method of claim. In one embodiment, the method that on receiving a certain kind of user input concerning a given conceptual object, the system will classify the given conceptual object as a relationship for the purpose of rendering it as such.

In one embodiment, the user can change the part of the knowledge graph that is being outputted or clustered by: zooming out, which, as used herein, means viewing both the notes that the user was originally viewing as well as some additional notes that are related to the notes she was previously viewing (all in possibly less detail than she was originally viewing them), zooming in, which, as used herein, means viewing a proper subset of the notes that the user was originally viewing, and also maybe additional information pertaining to the notes in the targeted proper subset, and traversing relations, i.e., navigating away from certain notes in the viewport and bringing other notes into the viewport.

In one embodiment, a plurality of users have input information that has affected the presentation or content of the notes. In one embodiment, there is a community of users associated with each shared knowledge graph, wherein: such users have the power to view or edit parts of said knowledge graph. In order for a user to contribute to a community's associated knowledge graph, the community is open to said user and the user opts into joining the community.

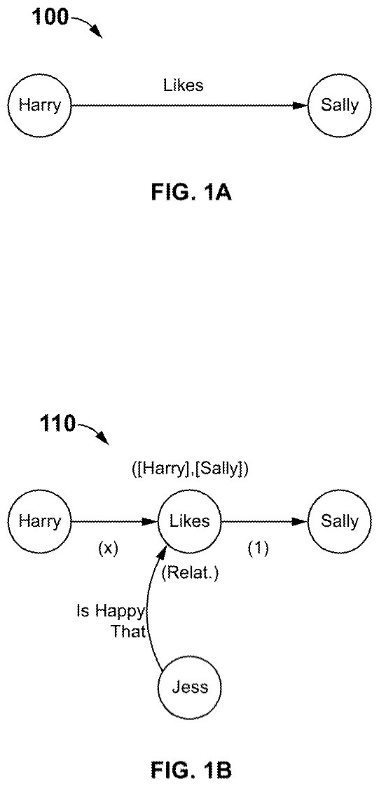

Referring to FIG. 1A, a knowledge graph 100 demonstrates a relationship between one or more conceptual objects, according to an embodiment of the present invention. In one embodiment, the knowledge graph 100 includes two conceptual objects. The conceptual objects could be stored in the knowledge graph 100. In the knowledge graph 100, any statement can be represented as a relation between conceptual objects. For example, to represent the sentence “Harry likes Sally,” assuming there is already a node labeled “Harry” and another node labeled “Sally,” the statement could be represented as an edge with label “likes” from “Harry” to “Sally,” as shown in FIG. 1A.

In one embodiment, it is possible to represent a connection wherein one of the conceptual of the connection is itself a connection. For example, in the statement “Jess is happy that Harry likes Sally,” [Jess] is the source conceptual object and the relation [likes] (between [Harry] and [Sally]) is the target conceptual object. The complex statement “Jess is happy that Harry likes Sally” cannot be formed if [likes] is not a conceptual object, and it cannot be a conceptual object if it is implemented solely as an edge. Therefore, there has to be a way of representing the relation between [Harry] and [Sally] itself as a conceptual object for the complex statement. FIG. 1B illustrates a knowledge graph 110 that demonstrates the aforementioned complex. In one embodiment, the knowledge graph 110 uses three conceptual objects. The conceptual objects could be stored in the knowledge graph 110.

In one embodiment, it is possible to convert the target relationship to a conceptual object by replacing [likes] with a new node that connects [Harry] and [Sally], then constructing an edge labeled “is happy that” from [Jess] to [likes] as shown in FIG. 1B. FIG. 1B exemplarily illustrates a method of converting a relationship that is implemented as a single edge into a conceptual object. The method is referred to as “nodifying” the original relation. The node corresponding to “likes” serves as a connection from “Harry” to “Sally.” In the context of the statement “Jesse is happy that Harry likes Sally” “likes” connects “Harry” to “Sally”. It can also serve as a conceptual object in other contexts, for example, the context of [Jess]. Such conceptual objects, as shown in FIG. 1B, include concept maps, are marked with a parenthetical “(relat.)” below the circle of the given conceptual object in order to indicate that they play the role of a relation in at least some contexts.

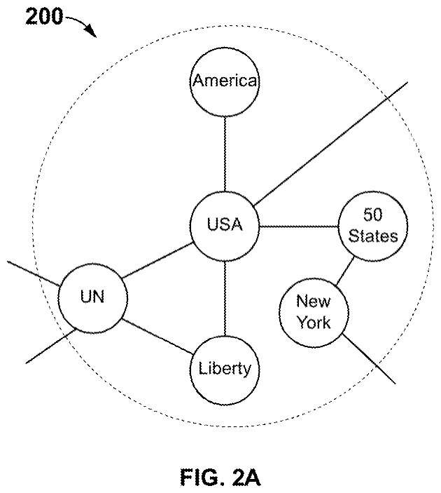

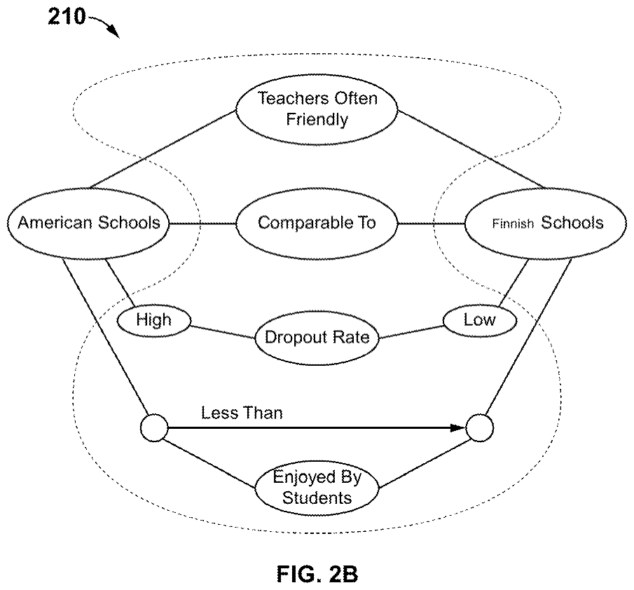

Referring to FIGS. 2A-2B, a connection (200, 210) between certain complex conceptual object and a certain complex relation between conceptual objects respectively, according to one embodiment of the present invention. In one embodiment, the conceptual object could be implemented by more than a single node. Similarly, the relation could be implemented by more than a single edge. Insofar as a concept gets its meaning from its connections to other concepts, the meaning of any particular conceptual objects should often be seen as distributed among multiple conceptual objects and the connections between them, as in the case when a cluster of nodes is interpreted as a conceptual object itself, as shown in FIG. 2A. In addition, a relation between two conceptual objects may be implemented as a path or set of paths between them, as shown in FIG. 2B.

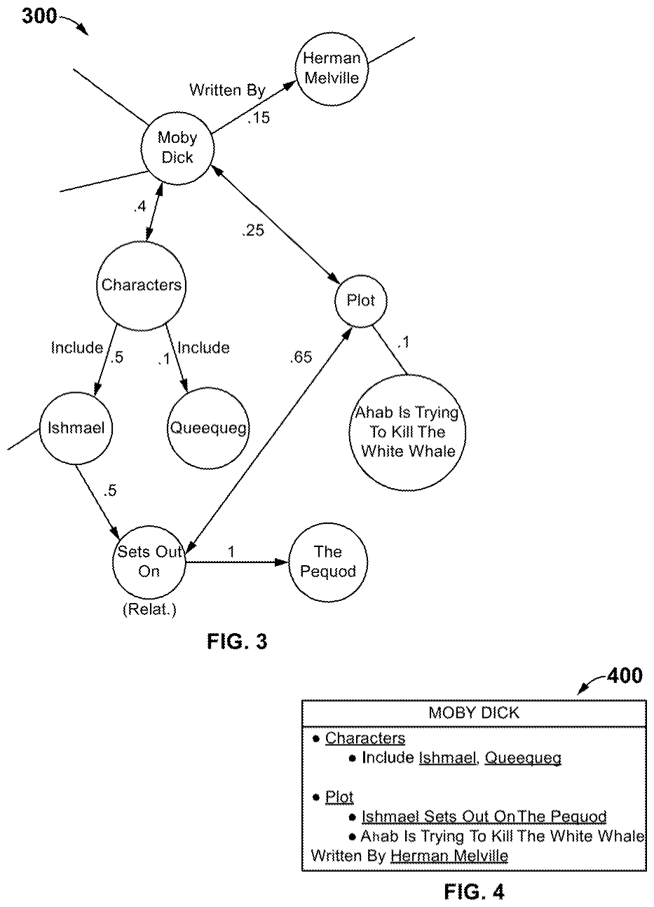

Referring to FIG. 3, a concept map 300 representing a portion of a knowledge graph, according to one preferred embodiment of the present invention. In one embodiment, a note-interaction system is a main system of the present invention that stores notes as the knowledge graph. The system is implemented in a computer comprises an output device and an input device. In one embodiment, the output device is a screen. In one embodiment, the input device is a keyboard and trackpad. In one embodiment, the outputted knowledge graph is a concept map 300. FIG. 3 displays the concept map 300 representing a knowledge graph pertaining to the novel Moby Dick.

Referring to FIG. 4, a page 400 with a title and bullet points, representing a portion of a knowledge graph, according to another preferred embodiment of the present invention. In one embodiment, a method is utilized for rendering outputting a knowledge graph or sub-graph thereof as a page of bullet points. In one embodiment, the page comprises a title and bullet points. In one embodiment, the title is the label of a conceptual object of interest. In one embodiment, the title and the bullet points are strings of text comprising data about the relation between the title conceptual object and another conceptual object 0. Such string may consist of the relation's label, followed by O label, or vice versa if the title conceptual object is the target rather than the source of the given relation.

In one embodiment, a method is employed by the knowledge graph displayed in FIG. 4 that renders some bullet points as indented under others. The method determines for each possibly indented bullet-point b, whether the target conceptual object of the relation that corresponds with b is sufficiently related to a target conceptual object of the bullet point under which b may be indented. The underlined text shown in FIG. 4 represents a conceptual object and non-underlined text represents a relation. The knowledge graph displayed in FIG. 4 corresponds to a spanning tree of the knowledge graph displayed in FIG. 3. Moby Dick is the title conceptual object, which is directly connected to the conceptual obj ects of the most out-dented bullet-points. The conceptual objects of the most outdented bullets are each directly connected to the conceptual objects of the bullet points that are indented beneath them. Rendering the output of the system in this bullet-point format is not only a potentially effective rendering in-and-of-itself, but may also provisionally serve to usher forth a transition to knowledge-graph-based note-interaction systems in general.

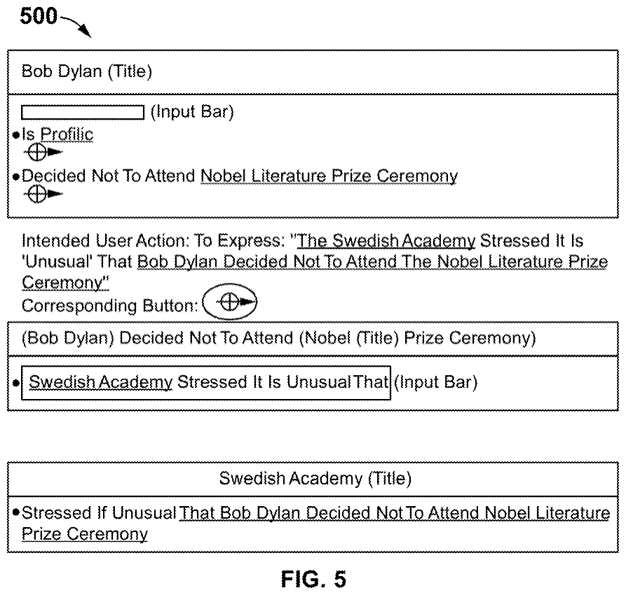

Referring to FIG. 5, a series of snapshots 500 for treating a relationship as a conceptual object that represents a knowledge graph as bullet points, according to an embodiment of the present invention. The snapshot 500 displays three bullet-points-views of the different sections of the same knowledge graph, wherein the system enables the user to nodify relations. The transition between the top and middle viewport snapshots display displays stages that precede and follow the execution of the method of nodifying a relation. The top viewport displays a page where [Bob Dylan] is the title conceptual object and the bullets are relations from [Bob Dylan] to [prolific] and to [Nobel literature prize ceremony].

In one embodiment, a viewer of the top viewport intends to add a note about the relation [decided not to attend] (between [Bob Dylan] and [Nobel literature prize]). In other words, the user intends to express “The Swedish Academy stressed it is unusual that Bob Dylan decided not to attend the Nobel literature prize ceremony.” The statement uses [decided not to attend] as the target conceptual object. Thus, adding the desired statement to the knowledge graph first requires nodifying [decided not to attend], then adding a relation [stressed it is unusual that] between the newly produced conceptual object and [Swedish Academy]. In the illustrated system, nodifying the relation results in the user's navigating to a new page where the relation is the title conceptual object with [decided not to attend] as the title conceptual object, the user can then add, as a new bullet, the original intended relation (between [Swedish Academy] and the now title conceptual object). Navigating to the page of [Swedish Academy], wherein [Swedish Academy] is the title, results in the system's expressing the newly added relation with equivalent substance in a slightly altered format.

Further, one or more computer-implemented methods that organize or manipulate knowledge graphs in manners that may resemble thinking are discussed as follows. Each of these methods could be helpful for a user when executed in response to the user's input. The routine or sporadic execution of these methods, not necessarily concurrent with user interactions. It may also transform the knowledge graph as manners, which are helpful for a future user. The methods described below may all be implemented in the above-described main system of the present invention, but their potential application is not limited to implementation in this system.

In one embodiment, a knowledge graph is provided, which can be too large for a user to ingest all at once. The methods that enable a user to traverse a knowledge graph, that is, the methods that enable users to move from focusing on a certain set of conceptual objects and relationships to focus on another set of conceptual objects and relationships, which are key for users to effectively access the contents of the knowledge graph. In one embodiment, the computer-implemented methods for traversing a knowledge graph takes as input an data concerning the current relevance of each of a set of conceptual objects and runs an algorithm to score the most relevant conceptual objects (given the conceptual object of interest) and outputs information about those conceptual objects. In one embodiment, the information is emphasized in the output according to the conceptual object's score. It is helpful in several contexts for a user to efficiently submit a query that singles out particular conceptual objects for use by the computer-implemented methods. But such efficiency is particularly helpful in the context of a knowledge graph, where it is more likely that the user will desire to (or just be able to) jump from node to node, often along connections.

In one embodiment, the present invention discloses a method for streamlining a user's process of inputting and submitting a query. The method provides a quicker way of enabling a user to input and submit a query for a single item from a list of items without needing to separately submit the expression-to-be-queried by providing a kind of input (e.g., a button press). The list of items could include, but not necessarily contain conceptual objects or connections of a knowledge graph. The method involves monitoring a user's query input process such that when the likelihood that the query is meant to pick out a particular list item exceeds a given certainty threshold, the query expression is submitted without a submission-input required from the user.

In one embodiment, the method may be implemented in an interface that takes typing as query input, wherein the user is, via the query, intends to single out one particular conceptual object for further focus. In one embodiment, the user's query input filters through conceptual objects by their corresponding labels. The method, after each of the user's keystrokes, determines whether the full text that they have inputted thus far, in this instance of querying, singles out the label of a particular conceptual object to an extent that exceeds a given certainty threshold. If, after any keystroke, the string inputted thus far sufficiently picks out the label of a particular conceptual object O, the method will output O as the result of the query. In a preferred embodiment, by the beginning of the user's query input process, each item in the list being queried already has an associated score or rank. Such a score or rank indicates the item's relevance. In a preferred embodiment, a threshold would be set to a point such that, given the relevance of all items in the list at the time of the query, a query is said to pick out one item enough if it is nearly certain that the user intends to query it.

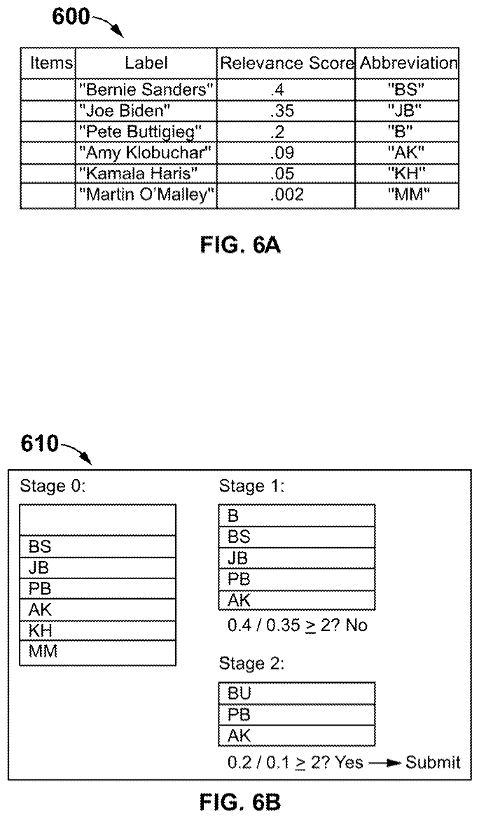

FIGS. 6A-6B illustrate a table representing a set of items and their relevance scores along with a series of snapshots (600, 610) of a method for fast querying, according to an embodiment of the present invention. The series snapshots (600, 610) shows an example of a keyboard-implemented instantiation of the method. FIG. 6A displays a table 600 having a set items along with their associated relevance scores for each (possibly national polling numbers). FIG. 6B displays snapshots 610 of a user query process, in which the user is querying by label for particular item within a list of items that includes the items in FIG. 6A. The threshold used in this example is achieved by the top-ranked item if its relevance score is at least twice the relevance score of the next most relevant item.

At Stage 0, the input field is blank, and all of the items are presented in a dropdown menu in order of relevance scores. At Stage 1, a user has typed “B” into the input field, which eliminates [Kamala Harris] and [Martin O'Malley] from contention. The relevance score of the first-ranked item, [Bernie Sanders], is not at least twice as great as the relevance score of the second-ranked item, [Joe Biden], so no automatic submission occurs. At Stage 2, a user has typed an additional character such that the current input is “Bu”. This query filters out [Bernie Sanders] and [Joe Biden], leaving [Pete Buttigieg] and [Amy Klobuchar] as the first- and second-ranked items, respectively. The relevance score of [Pete Buttigieg] is at least twice as great as the relevance score of [Amy Klobuchar]. Thus, [Pete Buttigieg] is submitted as the target of the query. It is noted that the threshold may be implemented in a variety of ways for example, the input could be aural, as well as that this querying method may be implemented in conjunction with an option for manual submission.

The querying method of the present invention allows for a more efficient type of querying, wherein more information about the items at hand than is typically considered in such a query process is considered in the determination of which particular item a user is attempting to pick out. This process parallels one that occurs in everyday conversation, where one person tries to put words to something they have in mind until the recipient understands what the first person has in mind.

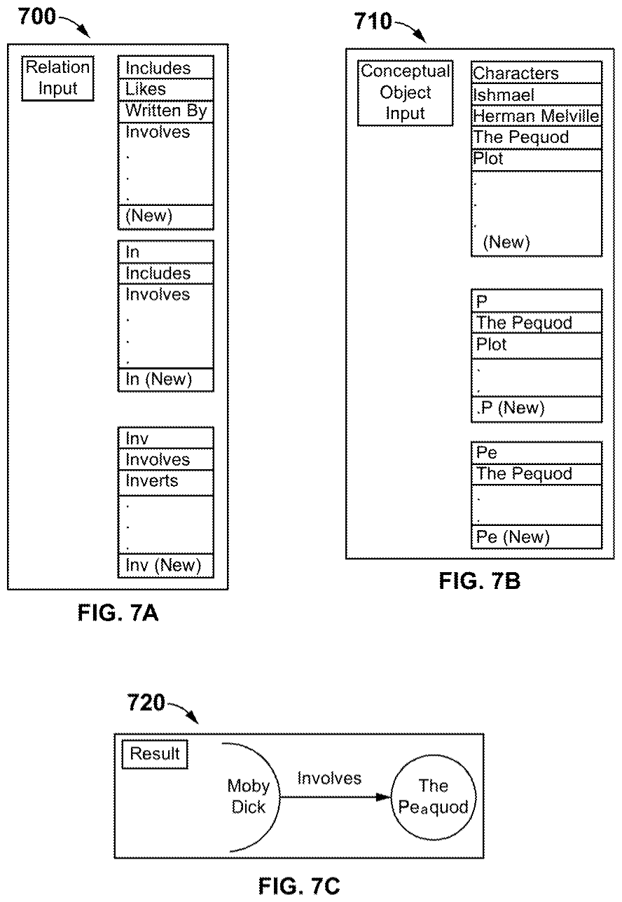

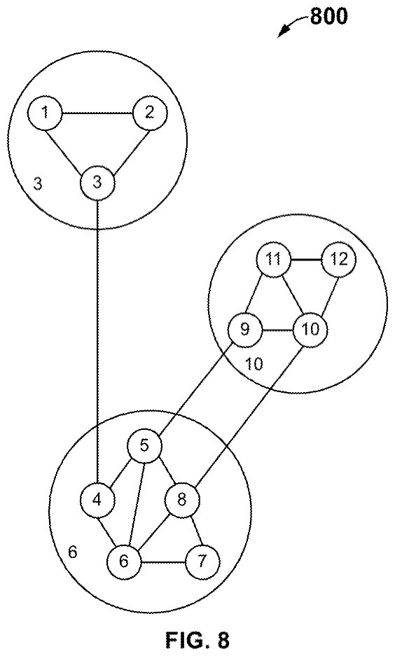

FIGS. 7A-7C illustrate a series of snapshots (700, 710, and 720) illustrating a method for enabling a user to quickly add connections to a knowledge graph, according to an embodiment of the present invention. In one embodiment, the method streamlines the process of adding a connection to a knowledge graph. The knowledge graph is largely concerned with details of Moby Dick. The conceptual objects of the knowledge graph are ranked and the relations are ranked, both according to their calculated relevance. In this example, the user's intention is to input the statement “Moby Dick involves The Pequod.” [Moby Dick], [involves], and [The Pequod] all happen to already be elements in the given knowledge graph. It is implicit in the underlying system. In one embodiment, it is implicit that any relations being added use [Moby Dick] as the source conceptual object. When the user is inputting the label of the relation (“involves”) or of the target conceptual object (“The Pequod”), the method populates and renders a menu of options for the user in order of the relevance of those options in case the user's intended new note uses as a label for either field that is already present in the knowledge graph. While the predicate “involves The Pequod” is 19 characters-long, by autofilling, the method enables the user to add the same statement with only five characters (possibly plus one key being pressed to transition from relation-adding to node-adding).

There will be situations when the user desires to add a relation in which the labels of the relation and target conceptual object are both new to the knowledge graph, in which case this method is not suitable. Nonetheless, the method parallels human thinking in that it is often not need to hear or read the full name of a concept or relation in order to understand the intended referent. This natural tendency allows for quicker reasoning in everyday life and the corresponding method of the present invention allows for quicker note-taking.

In one embodiment, the present invention utilizes a method that addresses the fact that people may have access to repositories of knowledge that are too large to effectively ingest all at once. The method summarizes, via clustering, a given knowledge graph. In one embodiment, the given knowledge graph may itself correspond to the subgraph of a larger knowledge graph. The method comprises finding a k-clustering of the given conceptual objects in the subgraph, where k is within some given desired range, and outputs information that is representative of each of the k clusters. In one embodiment, the information presented about the given cluster relates to a member conceptual object that has been determined as particularly representative of the given cluster. If the algorithm used for detecting clusters involve to find a medoid for each cluster, the medoid could, conveniently, be the representative node. The information displayed for the cluster, then, could be the corresponding medoid's label.

FIG. 8 illustrates a concept map 800 representing a knowledge graph, overlaid with circles representing a set of three clusters that may be detected for the knowledge graph, according to an embodiment of the present invention. The concept map 800 displays an example of the method for summarizing via clustering. The displayed concept map represents a given knowledge graph with twelve atomic conceptual objects as well as edges between them. Clusters are indicated as the groups of nodes contained within the enclosed outlines. It should be clear that in each group of nodes, the member nodes are roughly more connected to each other than to nodes outside of the group. The number associated with each cluster (just inside the outline of the cluster) is the number of what has been determined to be the most representative or central node within the cluster. In addition, it is possible to determine different metrics for clusters. The closed outlines of FIG. 8 display only one such possibility. If it is determined that seeing information associated with each of the 12 nodes at once is unwieldy, one method of summarizing via clustering could be applied to find the three displayed clusters, remove the conceptual objects within each cluster from the output device, leaving just the three outlines for the three clusters along with the label of the most representative member conceptual object of each cluster. Such a method would produce a view that, in effect, serves as a summary of the underlying information for any viewer. The view that results from replacing the original conceptual objects with conceptual objects that represent each cluster as a whole is hereafter referred to as a “summary-view”.

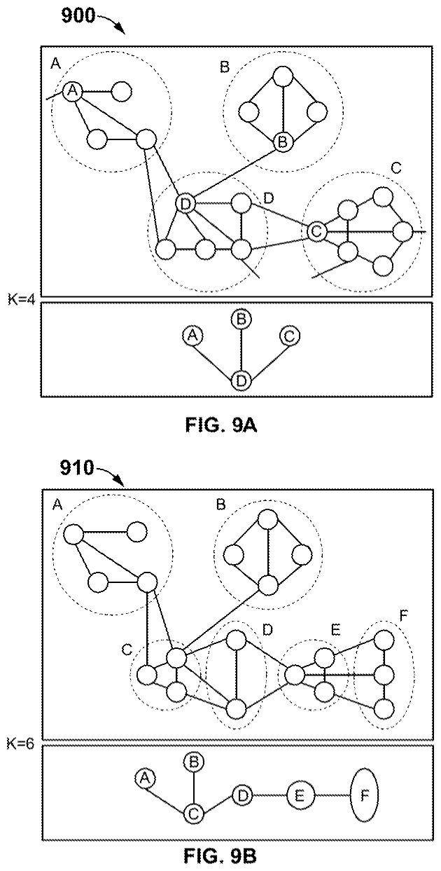

FIGS. 9A-9B illustrate a series of snapshots (900, 910) of a system that represents clusters as conceptual objects, according to one embodiment of the present invention. The snapshots (900, 910) shows an implementation of a user-triggered method summarizing via clustering of the present invention when implemented a concept-map-based note-taking system. FIG. 9A shows, on top, a four-clustering and the most the central nodes in each cluster ([A], [B], [C], [D]). Just below is a snapshot of what a summary-view that uses the four clusters, where the representative data displayed about each cluster is particular to the most central node inside the cluster. In the summary-view, there are edges between two clusters if and only if there is at least one edge between one of the conceptual objects within the first cluster and one of the conceptual objects in the second cluster.

FIG. 9B, shows, on top, a six-clustering of the same knowledge graph as in the top of FIG. 9A and the bottom is a summary-view that uses those six clusters. One system of the present invention enables a user to transition between different zoom levels, and, correspondingly, between different cluster views. In one embodiment, the system displays different views of the knowledge when the user has input different zoom levels. For example, let the given maximum number of clusters be six. Imagine that the user starts zoomed in such that only the conceptual objects in cluster [D] are output. Cluster [D] may not have been found yet. There are just five nodes, so no clustering-summarization should occur. Zooming out to the knowledge graph displayed at the top of FIG. 9B would bring 19 conceptual objects into view, which is greater than the maximum cluster of six. Thus, the method of summarizing via clustering is triggered, finding six clusters and representing them as in the bottom of FIG. 9B. Zooming out a bit more to include about ten new nodes could produce a summary-view including the snapshot on the bottom of FIG. 9A, where these 19 nodes are represented as four clusters/conceptual objects and presumably, the other ten are represented as about two.

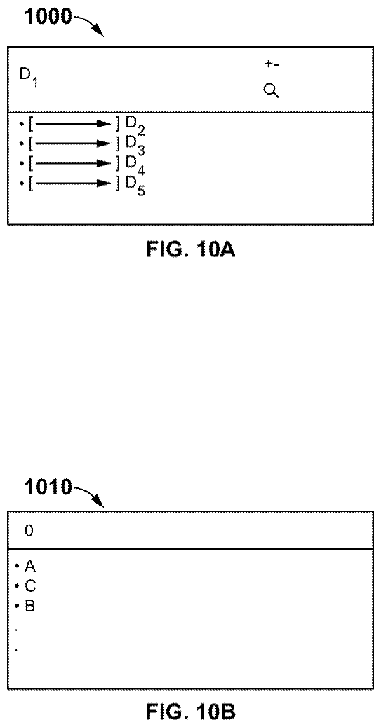

FIGS. 10A-10B exemplarily illustrate a diagram (1000, 1010) representing the addition of a connection incident to cluster that is being treated as a conceptual object, according to one embodiment of the present invention. It shows an implementation of the user-triggered method summarizing via clustering in a knowledge-graph-based note-taking system that outputs a given part of a knowledge graph as bullets points, where such a system is described above in relation to FIG. 4 and FIG. 5. In one embodiment, the knowledge graph stored by this system is the knowledge graph stored by the system of FIGS. 9A-9B. The top snapshot 1000 in FIG. 10A shows a page with title [D1] and its relations to four other conceptual objects. If the user indicates that they would like to figuratively zoom out, i.e., that they would like the output to present a larger swathe of the knowledge graph than is currently being output, the method considers a larger group of conceptual objects, including the output in the top snapshot 1000. Then, the number of conceptual objects in the group exceeds a given maximum, the method finds four clusters and only outputs representative information about each (hiding information about each particular constituent conceptual object), as displayed in the bottom snapshot.

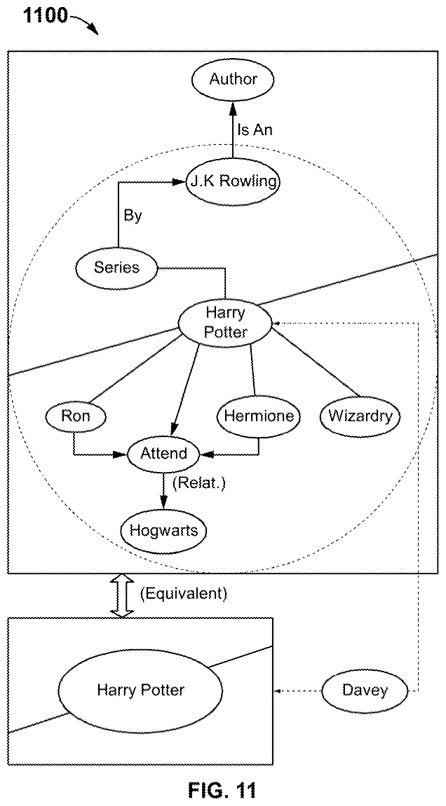

In one embodiment, the knowledge-graph-based note-taking system treats clusters as conceptual objects and enables the user to modify them like any other conceptual objects. Such modifications may include editing the label associated with the conceptual object or adding a relation between it and another conceptual object. FIG. 11 illustrates a pair of snapshots 1100 illustrating how a system that renders parts a knowledge graph as bullet points could enable a user to summarize notes by employing a method involving clustering, according to one embodiment of the present invention. It shows a group of conceptual objects, implemented as nodes, on the top, then a clustered summary-view of them on the bottom. In the bottom view, the label “Harry Potter” is displayed because the system determined that [Harry Potter] is the most central conceptual object, and node, in the above diagram. In one embodiment, the bottom view is being output by the system for a user. In one embodiment, the user indicates, via some input device, that they would like to add a connection between [Harry Potter] and [Davey].

The connection to modify the representative node is shown in FIG. 11, where the label of which is being displayed as representative information concerning the cluster. With this approach, adding an edge between the [Harry Potter] cluster and [Davey] is stored as an edge between the underlying [Harry Potter] node and [Davey]. A user could edit the label of the [Harry Potter] cluster, which could be stored in the same manner, affecting the underlying [Harry Potter] node. This method of changing the underlying knowledge graph in correspondence with a user's edits to a cluster works particularly well because the changes occur in both directions. Making changes to the cluster causes corresponding to the representative node. And also, making changes to the corresponding representative node would cause the corresponding changes in the cluster.

Adding an edge to [Davey] from the underlying [Harry Potter] node causes an edge to appear between the [Harry Potter] cluster and [Davey]. Adding an edge to [Davey] from the [Harry Potter] node causes an edge to appear between the underlying [Harry Potter] node and [Davey]. It is assumed that an application of the clustering method does not affect the underlying knowledge graph. It should be noted, however, that the method described in the context of FIG. 11 is not the only method of modifying the underlying knowledge graph. Another such method of modifying the underlying knowledge graph is, on the user's editing of the cluster label or adding a connection between the cluster and another conceptual object, adding a new node to the graph that explicitly represents the cluster and making the corresponding changes to that node.

In one embodiment, the present invention utilizes another category of methods for manipulating a knowledge graph for the benefit of a user involves detecting semantic similarity between knowledge graphs. The knowledge graphs being compared may be two sub-graphs of one larger knowledge graph. The methods may determine similarity between knowledge graphs based on a variety of factors, including, but not limited to, the distance between them in the context of a greater knowledge graph, their structural resemblance (whether there is near-isomorphism), and similarity between their labels. One such method involves suggesting desirable connections after finding sets of highly similar knowledge graphs.

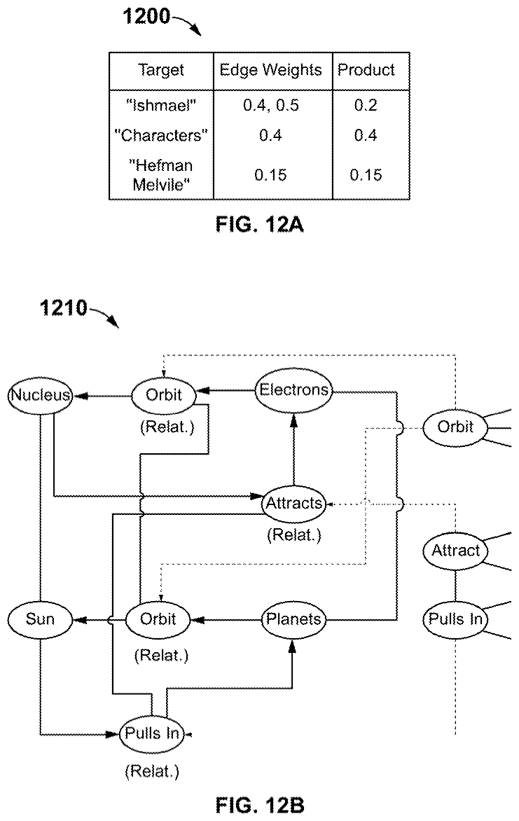

In one embodiment, the method suggests that an edge be constructed between two conceptual objects after judging that those two conceptual objects are highly similar to each other. Example data for such a scenario is displayed in the table of FIG. 12A. In one embodiment, the similarity measurements primarily take into account the edge-weighted distance from one node to another in a graph, where such a distance is calculated as the product of the edges in the least costly path from the source conceptual object to the target. Then, the relation between [Moby Dick] and [Ishmael] has strength 0.2, the relation between [Moby Dick] and [Characters] has strength 0.4, and the relation between [Moby Dick] and [Herman Melville] has strength 0.15. Even though [Moby Dick] shares an edge with [Herman Melville] but not with [Ishmael], the similarity metric being used finds that [Ishmael] is more closely related.

In one embodiment, a threshold for similarity is provided, where the method could suggest an edge from [Moby Dick] to [Ishmael], representing a direct connection between the two, only if their similarity (0.2) exceeds the given threshold. Alternatively, the prominence of the suggestion could correspond to the extent of similarity between the two conceptual-objects-to-be-connected, without any need for a threshold. In another embodiment, a user is viewing a page where [Moby Dick] is at the top (a title of sorts), and all the most “similar” nodes in the graph are presented in order of similarity below the title, where for all nodes without a direct connection to [Moby Dick], a direct connection is suggested. In this case, the prominence of the suggestion corresponds to its spatial positioning relative to other conceptual objects in the list.

In another embodiment, the method for suggesting desirable connections after finding sets of highly similar knowledge graphs involves structural similarity among subgraphs of a knowledge graph. It is a method for detecting analogies, iterating through many possible comparisons of subgraphs of the given knowledge graph, measuring the similarity which, in this case, involves structural similarities like near isomorphism and recording the set of subgraphs together if their similarity score exceeds a certain threshold. In one embodiment, for the sake of illustration that the sets of sub-graphs of are sets of two. Then, the sub-graphs with particularly high similarity are suggested to as an analogy.

FIG. 12B illustrates an instance that nearer sub-graphs are compared before ones that are farther apart from each other, where an ordering is selected for the sake of efficiency, given the assumption that closer sub-graphs are more likely similar or relevant to compare than sub-graphs that are farther away from each other. In FIG. 12B, two sub-graphs are detected as structurally similar. The top sub-graph of interest is the sub-graph induced by [nucleus], [electrons], and the directly connected conceptual objects [orbit] and [attracts]. The bottom sub-graph of interest is the sub-graph induced by [sun], [planets], and the directly connected conceptual objects [orbit] and [pulls in]. The dashed lines relate the conceptual objects labeled “orbit,” “attract,” and “pulls in” to more central conceptual objects that relate to the relations denoted by those labels—both to the particular instances of those relations displayed in the figure but also to other instances.

The edges, in one example, represented by those dashed lines are present, the two sub-graphs of interest might then be considered relatively near to each other, given that there are paths from one to the other through those concepts. As a result, these two substructures are compared before others are compared. The method detects a structural isomorphism between the two sub-graphs in addition to their nearness. The dotted lines indicate the isomorphism mapping. The method then gives the pair of sub-graphs a similarity score, which very well may the given similarity threshold. In this example it is clear that similarity in the structure of these nearby sub-graphs truly indicates an analogy: both are orbital systems of some sort.

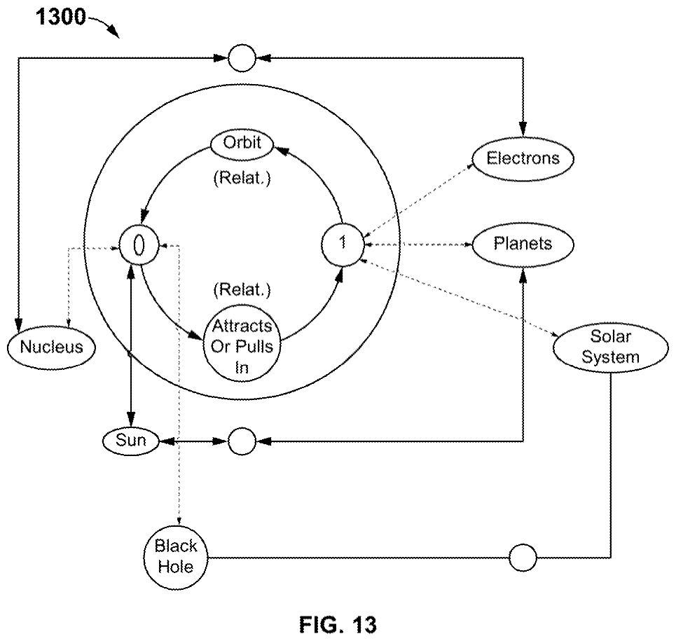

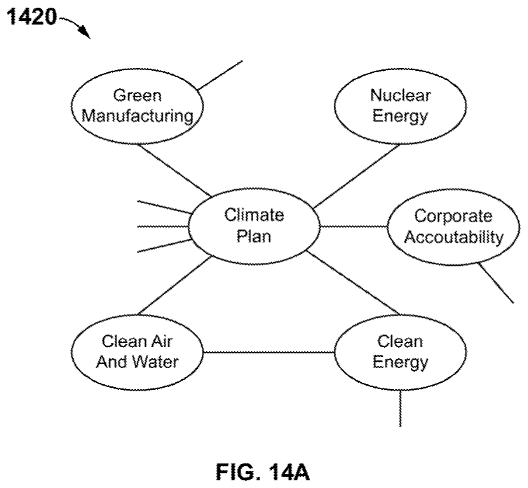

In one embodiment, the present invention utilizes another method for finding semantic similarities within or across knowledge graphs. The method abstracts the similarities from such sets of similar sub-graphs by building a prototypical knowledge graph structure that possesses the overlapping features. FIG. 13 illustrates a concept map 1300 representing a knowledge graph in which a prototype has been constructed to represent the similarity of a pair of similar knowledge graphs, according to one embodiment of the present invention. The prototypical knowledge graph structure, which be may interpreted as the concept of an orbital system, is the sub-graph induced by the conceptual objects [orbit], [attracts OR pulls in], [0], and [1]. This prototypical structure represents the overlapping features of the two sub-graphs of interest in FIGS. 12A-12B. Each of those sub-graphs has a perfect isomorphism with this prototypical structure. Also, the [attracts] or [pulls in] conceptual objects in the FIGS. 12A-12B sub-graphs corresponds to the [attracts OR pulls in] conceptual object of the prototypical structure. Further, the [orbit] conceptual objects of the sub-graphs of interest in FIGS. 12A-12B correspond to the [orbit] node of the prototypical structure.

The prototypical structure enables a possibly more memory efficient representation of the two sub-graphs of FIGS. 12A-12B. By connecting [nucleus] to [0] and [electrons] to the [1], and [nucleus] and [electrons] to some other node, which represents this instance of their substitution for the blank nodes in the prototypical structure, the top sub-graph of FIGS. 12A-12B has been represented using one fewer node. The same is true of the bottom sub-graph of FIGS. 12A-12B. Admittedly, there may be more edges. But, as the more instances of the prototype are found (e.g., galaxies, where solar systems orbit around black holes), the use of the prototype for storage becomes significantly more memory-efficient.

In one embodiment, the method compares the structures in a knowledge graph, temporally independent of any user's interactions with the graph, that finds prototypical structures and streamlines the manner in which sub-graphs that employ the prototypical structure are stored. This conversion parallels the transition from how the sub-graphs of interest in FIGS. 12A-12B are represented the way of inserting the sub-graphs in FIG. 13. The new representations do not reproduce the prototypical structures for each instance of it; they simply rely on the structure of the prototype and associate the proper sets of conceptual objects with it.

In another embodiment, the method further comprises assigning or letting a user assign an identifying key to the prototype that allows the prototype to be referenced as any other conceptual object in the knowledge graph. This method would allow a user to, after the prototype has been produced for [nucleus] and [sun] -centered systems, refer to the prototype quickly in further notes, either for the sake of referencing the prototypic concept itself or for instantiating new instances of the prototypic structure more efficiently. For example, if the prototypic structure of FIG. 13 is labeled “orbital system,” then a new orbital system, like a galaxy, could be specified as “an orbital system, where conceptual object [0] is [black hole] and conceptual object [1] is [solar system].” The specifics of how a user might input such a query are besides the point, where the point is that a note-interaction system that uses an abbreviation for abstracted prototypic concepts can enable significantly more efficiency in the storage of instances of that concept and in the effort it takes to use such concepts in the future.

In one embodiment, the present invention further utilizes a method that involves finding semantic similarity across knowledge graphs is a method of merging two knowledge graphs. Sets of highly similar sub-graphs that contain exactly one sub-graph from each knowledge graph under consideration are found through an iterative similarity comparison process among many sub-graphs. Then, such sets of high-similarity sub-graphs are overlaid onto each other, producing a new knowledge graph.

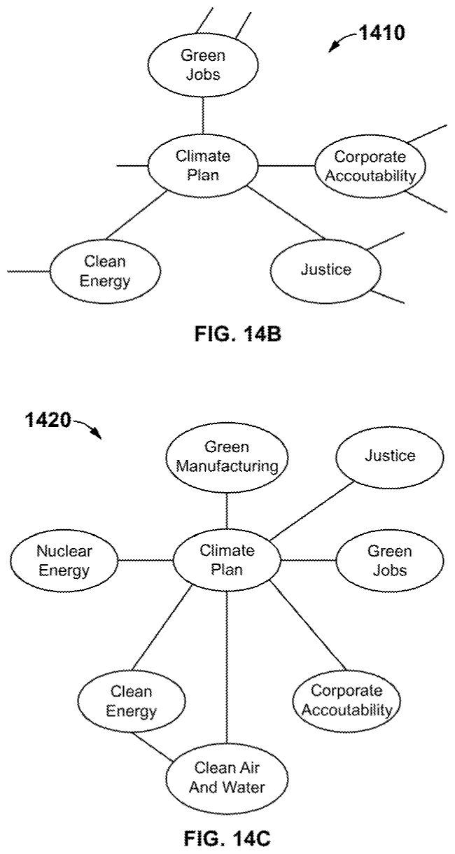

FIGS. 14A-14C exemplarily illustrates a set of concept maps (1400, 1410, and 1420) representing a method of merging the two knowledge graphs into a third knowledge graph, according to one embodiment of the present invention. It displays snapshots from such a merging process. The knowledge graph represented in FIG. 14A is possessed by a user named “Warren”. The knowledge graph represented in FIG. 14B is possessed by a user named “Sanders”. There cannot be a similarity metric based on distance, given that there is no path from one knowledge graph to a wholly separate one.

The similarity that is detected between the knowledge graphs in the example of FIGS. 14A-14B concern the structure and labels of corresponding conceptual objects. Specifically, both knowledge graphs have a node labeled “climate plan”. Both knowledge graphs have a conceptual object whose labels are “clean energy”. Further, both knowledge graphs have a conceptual object labeled “corporate accountability”. Structurally, the [climate plan] and [clean energy] conceptual objects share an edge in each respective knowledge graph configured to perform the [climate plan] and [corporate accountability] conceptual objects. This three-concept, two-edge structure is shared by both knowledge graphs and therefore, given some similarity threshold, could serve as the primary overlapping structure to be used for the merging process.

Using this shared sub-graph as an anchor, the knowledge graph displayed by FIG. 14C is obtained by searing together, across the two original knowledge graphs, the [climate plan] conceptual objects, the [clean energy] conceptual objects, the [corporate accountability] conceptual objects, and the relations between them. The three new super-conceptual objects ([climate plan*], [clean energy*], and [corporate accountability*]) are each incident to all edges possessed by any of the corresponding original conceptual objects in the two given knowledge graphs. For instance, in Warren's knowledge graph, [climate plan] shares an edge with [clean air and water], [clean energy], [corporate accountability], [environmental justice], and [green manufacturing]. In Sander's knowledge graph, [climate plan] also shares an edge with [green jobs] and [justice]. In the merged knowledge graph, the [climate plan*] conceptual object shares an edge with each of these other conceptual objects. With the proper similarity-finding algorithm, such a method would allow users to seamlessly merge notes.

In one embodiment, the present invention utilizes a method that enables users to collaborate in their note-taking. While the previously described method of merging works well when different parties take notes individually then wish to combine them, this method renders a knowledge graph to which multiple users have contributed. The rendering method outputs the conceptual objects and relations with which a given set of users U has interacted more prominently than the other notes in the graph. In one embodiment, the method explicitly distinguishes between the notes with which users in Uhave interacted and those with which users in Uhave not interacted. In a preferred embodiment, the rendering method is a system in which a plurality of users contribute to and traverse a shared knowledge graph. In such a system, each user sees the graph as rendered by the given method, where the set of users U only includes the given user.

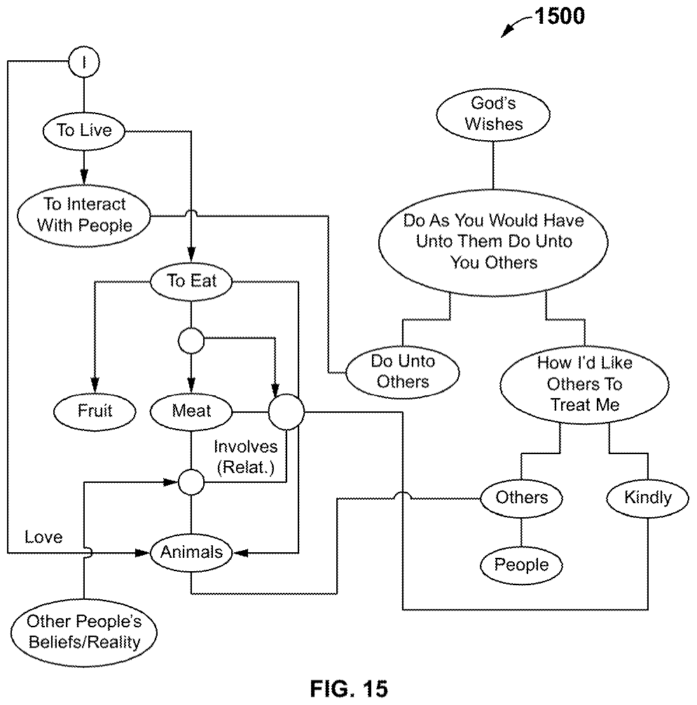

In one embodiment, the present invention utilizes a method that provides a set of preferences and a knowledge graph, finds a way of modifying connections to the graph in such a manner as to better satisfy the preferences. The preference is an aim of either increasing or decreasing the strength of the relations among a given group of conceptual objects. FIG. 15 exemplarily illustrates a concept map 1500 illustrating a process of preference satisfaction in a system that has a concept map and a preference, according to one embodiment of the present invention. There is one preference present in the example: the aim of living according to God's wishes and the aim of keeping all the knowledge consistent with other people's common-sense knowledge and beliefs about reality. There is also a strict cost function (i.e., constraint): the given knowledge graph must reflect a common-sense knowledge graph (derived possibly from finding the similarities across many individuals' knowledge graphs).

In one embodiment, the method finds a way of modifying connections in the knowledge graph as to better satisfy the given preferences through the following steps: At one step, consider the God's-wishes preference first and understanding the meaning of [to live] by considering neighboring nodes and incident relationships in the knowledge graph; At another step, understand the meaning of [God's wishes] by considering neighboring nodes and incident relationships in the knowledge graph; At another step, mark, as both of these meaningful traversal processes occur, paths that have been found from one of the initial conceptual objects ([to live], [God's wishes]) to the other initial conceptual object; At another step, record the edges in these relations that are particularly weak or inhibitory; At another step, construct or strengthen the connections between concepts that relate to [God's wishes] and to [to live] only if doing so does not sufficiently go against the other preferences.

In the illustrated example, the method detects that the first preference is prevented from being maximally connected with [to live] insofar as [to eat animals] is not strongly connected to [living kindly] and [to live] is strongly connected to [eating animals]. These connections may prevent maximal satisfaction of the God's-wishes preference because of an inhibitory (negatively weighted) path between [God's wishes] and [to live] that these connections compose. The given preference satisfaction method would output certain suggested modifications as a result. Because of the constraint that the knowledge graph must not run contrary to a given common-sense knowledge graph, certain modifications are ruled out from contention. For example, though removing the connection between [meat] and [animals] might diminish the inhibitory nature of a path between [to live] and [God's wishes], doing so would run contrary to the common-sense knowledge graph, insofar as the common sense knowledge graph contains a relatively strong relationship between [meat] and [animals].

After eliminating certain suggestions on this basis, the method produces the following two suggestions including weakening the connection between [to eat] and [meat] or between [others] and [animals]. In the case of a person, other preferences may be relevant to deciding which, if not both, of these choices to make.

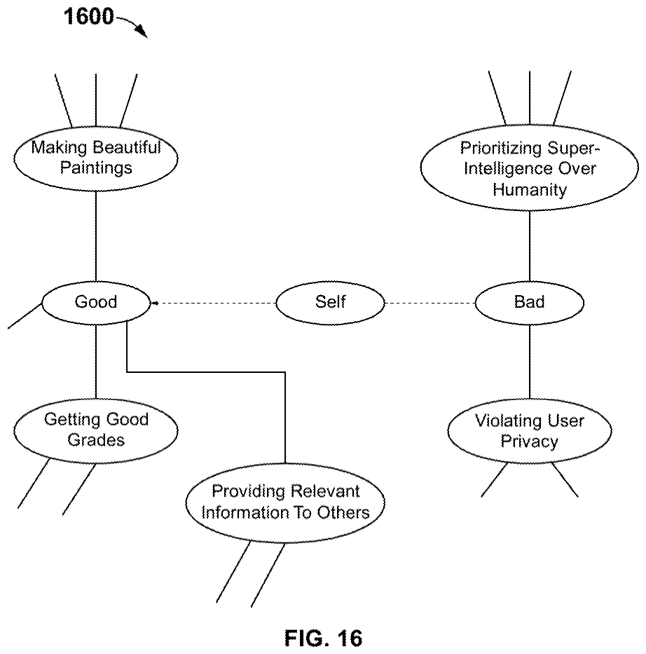

A paradigmatic pair of preferences that many people possess comprises the aim of strengthening the connection between one's concept of self and their concept of good and weakening the connection between their concept of self and their concept of bad. FIG. 16 exemplarily illustrates a concept map 1600 illustrating a pair of preferences that is paradigmatic for many people, according to one embodiment of the present invention. An example of this paradigm is illustrated in FIG. 16.

The advantages of the present invention includes, but not limited to, as certain conceptual objects can be relatively connected to actions that are within the power of a knowledge-graph-holder, this algorithm can be employed by an artificial agent that has a set of preferences.

One aspect of the present disclosure is directed to a computer-implemented method for rendering a dynamic, graph-based note-taking. The method comprises the steps of (a) converting an edge of a knowledge graph, representing a relation, into an edge-node-edge structure, representing a relation and a conceptual object, wherein the relation is implemented as an edge from a source node to a target node into a conceptual object; (b) presenting the knowledge graph in bullet-point form; (c) streamlining note-adding by enabling a user to quickly add an edge to a knowledge graph; (d) summarizing notes via clustering by taking the knowledge graph as input and a desired range for the number of clusters; (e) determining similar sub-graphs by finding a measure of semantic similarity between parts of the knowledge graph; (f) merging knowledge graphs by determining the sets of similar nodes; (g) generating a shared knowledge graph that has been created, modified, and traversed by a set of users; and (h) satisfying the preferences with the knowledge graph to an extent.

Another aspect of the present disclosure is directed to a computer-implemented method for rendering a dynamic, graph-based note-taking, comprising the steps of: presenting the knowledge graph in bullet-point form; streamlining note-adding by enabling a user to quickly add an edge to a knowledge graph; summarizing notes via clustering by taking the knowledge graph as input and a desired range for the number of clusters; determining similar sub-graphs by finding a measure of semantic similarity between parts of the knowledge graph; merging knowledge graphs by determining the sets of similar nodes; generating a shared knowledge graph that has been created, modified, and traversed by a set of users; and satisfying the preferences with the knowledge graph to an extent.

In one embodiment, the rendering of knowledge graph as bullet-points, comprising the steps of: (a) accessing a particular node in a knowledge graph, wherein each node has associated identifying information; (b) ranking the most relevant relations in the graph in an order based on their relevance, wherein, to reiterate, the relation is implemented in the knowledge graph either as an edge between two nodes or as a path or set of paths between two given nodes; and outputting a list of entries corresponding to each ranked relation, where each entry is a statement represented by information corresponding to the source conceptual object of the relation, the relation itself, and the target conceptual object of the relation.

In another embodiment, the method further comprises accessing a log, in chronological order, of the edges most recently added to the knowledge graph, and ranking the most relevant relations, wherein the relevance of a given relation corresponds to the recency of its addition to the knowledge graph.

In one embodiment, the streamlining of inputting and submitting the query, comprising the steps of: (a) accessing a set of items and a certainty threshold; (b) inputting the query as a string; (c) monitoring a user's input as the user is in the process of inputting a query; (d) determining at various instances of inputting a query whether the likelihood that the part of the query that the user has input singles out a particular item in the given set exceeds the given certainty threshold; and (e) submitting the query upon determining that the threshold has been exceeded.

In one embodiment, the information about the likelihood of any item's being sought out in a query is given by an element-ranking algorithm. In one embodiment, the streamlining of note-adding includes a repository of notes that are stored as the knowledge graph comprising: (a) ranking the conceptual objects and relations in the knowledge graph; (b) taking user inputs for a source node identifier, a target node identifier, and an edge name; (c) outputting and filtering the query for a conceptual object or relation, a menu containing the highest ranked conceptual objects or relations, respectively; and (d) auto-filling the selected item from the menu in the input field.

In one embodiment, the method further comprises auto-filling the input field, for each change made to a source or target node input field, with suggested information associated with the highest ranked node that matches the part of the query that has been input, and auto-filling the input field, for each change made to the edge name input field, with suggested information associated with the highest ranked edge that matches the query that part of the query that has been input.

In one embodiment, the summarizing of notes via clustering, further includes: applying clustering algorithm to the knowledge graph to find desired range clusters of nodes, and rendering to a viewer of an associated note-interaction system informational highlights concerning individual clusters of the clusters of concepts that are found, wherein the information includes information that relates in particular to a medoid in each given cluster. In another embodiment, the determination of semantic similarity between parts of a knowledge graph, comprising: computing the similarity between various pairs of sub-graphs of the knowledge graph; finding sets of sub-graphs whose members' similarity with each other exceeds a certain threshold, and outputting the sets to a user or to further processing steps.

In one embodiment, the method further comprises accessing information about the importance of each node in a subset of the nodes of the knowledge graph, and prioritizing, in the similarity computations, sub-graphs that are those more closely related to nodes with higher levels of importance, wherein the prioritization of the given sub-graph corresponds to considering its comparisons with other sub-graphs earlier than other comparisons.

In one embodiment, the method further comprises providing suggestions for possible modifications of the graph based on the sets of sub-graphs whose members have been determined to be sufficiently similar to each other. In one embodiment, each suggested modification constitutes the proposal of a connection between two conceptual objects, which are not already directly connected and which are contained within sub-structures that have been determined as similar to each other. In another embodiment, the similarity computation takes into account structural resemblance or the similarity of data that is associated with the nodes or edges being compared and outputs the knowledge graph information regarding some sub-graphs groups that have been determined to be most similar to each other, wherein such a grouping is presented as a semantic analogy.

In one embodiment, the method further comprises constructing a prototypical knowledge-graph structure composed of nodes and edges for each set of similar sub-graphs, either by abstraction to capture their similarities or by combining them so as to keep all of their features; adding some of the constructed prototype knowledge graph structures to the larger knowledge graph that contains the original sub-graphs that were identified as similar, and adding edges to connect the prototypical structure to some of the sub-graphs that belong to the category that the prototype represents.

In one embodiment, merging knowledge groups comprises finding sets of similar nodes, wherein each set consists of one or no sub-graph from each of the knowledge graphs and the similarity measure between any two members of a such a set exceeds a threshold number, and for members of each such set of similar nodes, either: connecting all nodes in the set to each other node in the set, by constructing edges connecting the nodes to each other so as to connect previously disparate knowledge graphs, replacing each of these nodes with one super node that has the connections possessed by each of the original nodes in this set.

In one embodiment, rendering the shared knowledge graph comprises taking as input all of the contributions made by user to the contemporaneous state of the knowledge graph, and rendering each element of the knowledge graph such that the element's prominence.

Another aspect of the present disclosure is directed to a note-interaction system that stores notes and connections between them as a knowledge graph and implements any of the above-claimed methods.

In one embodiment, the system further comprises an input device configured to enable a user to enter information that affects the presentation or the content of the stored notes. In another embodiment, the system further comprises an output device configured to render the knowledge graph as a concept map, wherein the output device is a digital viewport. In one embodiment of the system, the user changes the part of the knowledge graph that is being outputted or clustered by: (a) zooming out to view both the notes that the user was originally viewing as well as some additional notes that are related to the notes she was previously viewing (all in possibly less detail than she was originally viewing them); (b) zooming in to view a proper subset of the notes that the user was originally viewing, and also maybe additional information pertaining to the notes in the targeted proper subset; and (c) traversing relations by navigating away from certain notes in the viewport and bringing other notes into the viewport.

Another aspect of the present disclosure is directed to a note-interaction system that stores notes and connections between them as a knowledge graph and implements the method of the instantly disclosed invention. In one embodiment, the system further comprises an output device configured to render the knowledge graph as a concept map, wherein the output device is a digital viewport, and wherein the user changes the part of the knowledge graph that is being outputted or clustered by: zooming out to view both the notes that the user was originally viewing as well as some additional notes that are related to the notes she was previously viewing (all in possibly less detail than she was originally viewing them); zooming in to view a proper subset of the notes that the user was originally viewing, and also additional information pertaining to the notes in the targeted proper subset, and traversing relations by navigating away from certain notes in the viewport and bringing other notes into the viewport.

Another aspect of the instant disclosure is directed to a computer-implemented method for implementing dynamic, graph-based note-taking, comprising the steps of: (a) building a knowledge graph from user-inputted notes; (b) summarizing notes via clustering by taking the knowledge graph as input and a desired range for the number of clusters; and (c) rendering a shared knowledge graph that has been created, modified, and traversed by a set of users.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A computer-implemented method for rendering a dynamic, graph-based note-taking, comprising the steps of:
presenting a knowledge graph in bullet-point form;
streamlining note-adding by enabling a user to quickly add an edge to a knowledge graph;
summarizing notes via clustering by taking the knowledge graph as input and a desired range for the number of clusters;
determining similar sub-graphs by finding a measure of semantic similarity between parts of the knowledge graph;
merging knowledge graphs by determining the sets of similar nodes;
generating a shared knowledge graph that has been created, modified, and traversed by a set of users, and
satisfying the preferences with the knowledge graph to an extent.

2. The method of claim 1, wherein the presenting of the knowledge graph as bullet-points, comprises:
accessing a particular node in a knowledge graph, wherein each node has associated identifying information;
ranking the most relevant relations in the graph in an order based on their relevance, wherein, to reiterate, the relation is implemented in the knowledge graph either as an edge between two nodes or as a path or set of paths between two given nodes, and
outputting a list of entries corresponding to each ranked relation, where each entry is a statement represented by information corresponding to the source conceptual object of the relation, the relation itself, and the target conceptual object of the relation.

3. The method of claim 2, further comprising:
accessing a log, in chronological order, of the edges most recently added to the knowledge graph, and
ranking the most relevant relations, wherein the relevance of a given relation corresponds to the recency of its addition to the knowledge graph.

4. The method of claim 1, wherein the streamlining of inputting and submitting the query, comprising the steps of:
accessing a set of items and a certainty threshold;
inputting the query as a string;
monitoring a user's input as the user is in the process of inputting a query;
determining at various instances of inputting a query whether the likelihood that the part of the query that the user has input singles out a particular item in the given set exceeds the given certainty threshold, and
submitting the query upon determining that the threshold has been exceeded.

5. The method of claim 4, wherein the information about the likelihood of any item's being sought out in a query is given by an element-ranking algorithm.

6. The method of claim 1, wherein the streamlining of note-adding includes a repository of notes that are stored as the knowledge graph comprising:
ranking the conceptual objects and relations in the knowledge graph;
taking user inputs for a source node identifier, a target node identifier, and an edge name;
outputting and filtering the query for a conceptual object or relation, a menu containing the highest ranked conceptual objects or relations, respectively, and
auto-filling the selected item from the menu in the input field.

7. The method of claim 6, further comprising:
auto-filling the input field, for each change made to a source or target node input field, with suggested information associated with the highest ranked node that matches the part of the query that has been input, and
auto-filling the input field, for each change made to the edge name input field, with suggested information associated with the highest ranked edge that matches the query that part of the query that has been input.

8. The method of claim 1, wherein the summarizing of notes via clustering, further includes:
applying clustering algorithm to the knowledge graph to find desired range clusters of nodes, and
rendering to a viewer of an associated note-interaction system informational highlights concerning individual clusters of the clusters of concepts that are found, wherein the information includes information that relates in particular to a medoid in each given cluster.

9. The method of claim 1, wherein the determination of semantic similarity between parts of a knowledge graph, comprising:
computing the similarity between various pairs of sub-graphs of the knowledge graph;
finding sets of sub-graphs whose members' similarity with each other exceeds a certain threshold, and
outputting the sets to a user or to further processing steps.

10. The method of claim 9, further comprising:
accessing information about the importance of each node in a subset of the nodes of the knowledge graph, and
prioritizing, in the similarity computations, sub-graphs that are those more closely related to nodes with higher levels of importance, wherein the prioritization of the given sub-graph corresponds to considering its comparisons with other sub-graphs earlier than other comparisons.

11. The method of claim 9, further provides suggestions for possible modifications of the graph based on the sets of sub-graphs whose members have been determined to be sufficiently similar to each other.

12. The method of claim 11, wherein each suggested modification constitutes the proposal of a connection between two conceptual objects, which are not already directly connected and which are contained within sub-structures that have been determined as similar to each other.

13. The method of claim 9, wherein the similarity computation takes into account structural resemblance or the similarity of data that is associated with the nodes or edges being compared and outputs the knowledge graph information regarding some sub-graphs groups that have been determined to be most similar to each other, wherein such a grouping is presented as a semantic analogy.

14. The method of claim 9, further comprising
constructing a prototypical knowledge-graph structure composed of nodes and edges for each set of similar sub-graphs, either by abstraction to capture their similarities or by combining them so as to keep all of their features;
adding some of the constructed prototype knowledge graph structures to the larger knowledge graph that contains the original sub-graphs that were identified as similar, and
adding edges to connect the prototypical structure to some of the sub-graphs that belong to the category that the prototype represents.

15. The method of claim 1, wherein merging knowledge groups comprising:
finding sets of similar nodes, wherein each set consists of one or no sub-graph from each of the knowledge graphs and the similarity measure between any two members of a such a set exceeds a threshold number, and for members of each such set of similar nodes, either:
connecting all nodes in the set to each other node in the set, by constructing edges connecting the nodes to each other so as to connect previously disparate knowledge graphs,
Replacing each of these nodes with one super node that has the connections possessed by each of the original nodes in this set.

16. The method of claim 1, wherein rendering the shared knowledge graph comprises:
taking as input all of the contributions made by user to the contemporaneous state of the knowledge graph, and
rendering each element of the knowledge graph such that the element's prominence.

17. A note-interaction system that stores notes and connections between them as a knowledge graph and implements the method of claim 1.

18. The system of claim 17, further comprising an input device configured to enable a user to enter information that affects the presentation or the content of the stored notes.

19. The system of claim 17, further comprising an output device configured to render the knowledge graph as a concept map, wherein the output device is a digital viewport, and wherein the user changes the part of the knowledge graph that is being outputted or clustered by:
zooming out to view both the notes that the user was originally viewing as well as some additional notes that are related to the notes she was previously viewing (all in possibly less detail than she was originally viewing them);
zooming in to view a proper subset of the notes that the user was originally viewing, and also additional information pertaining to the notes in the targeted proper subset, and
traversing relations by navigating away from certain notes in the viewport and bringing other notes into the viewport.

20. A computer-implemented method for implementing dynamic, graph-based note-taking, comprising the steps of:
building a knowledge graph from user-inputted notes;
summarizing notes via clustering by taking the knowledge graph as input and a desired range for the number of clusters; and
rendering a shared knowledge graph that has been created, modified, and traversed by a set of users.
